(19) United States
(12) Patent Application Publication
(10) Pub. No.: US 2008/0272145 A1
(43) Pub. Date: Nov. 6, 2008

(54) Fluid Delivery Device

(75) Inventors: Chris Nimmo, Bucks (Grande-Bretagne) (GB); Olivier Bertaud, Boulogne (FR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: LABORATOIRES GOEMAR S.A., SAINT MALO (FR)

(21) Appl. No.: 11/816,053

(22) PCT Filed: Feb. 14, 2006
(86) PCT No.: PCT/FR2006/000338

§ 371 Date: Aug. 10, 2007

(30) Foreign Application Priority Data
Feb. 15, 2005 (FR) 0501511
Nov. 15, 2005 (FR) 0511571

(51) Int. Cl. B65D 35/28; B65D 35/56; B67D 5/42

(52) U.S. Cl. 222/95; 222/105; 222/386.5

(57) ABSTRACT

The invention relates to a device of the type adapted to deliver fluids, notably medicaments, under pressure. The device comprises a container 1 of variable volume in the form or shape of a pouch or flexible receptacle of generally cylindrical shape with longitudinal pleats 2 containing the fluid under pressure to be delivered and equipped with an actuator C permitting to open a valve 15a, 15b to enable the delivery of said fluid, the whole being located inside a container 4 capable of resisting to an elevated internal pressure, the internal volume of the latter container comprised between its wall and the container of variable volume being filled with a neutral gas under a pressure sufficient to exert on the container of variable volume a pneumatic constraint sufficient to permit the delivery of the therein contained fluid when the above-said valve permitting said delivery is operated by the aforementioned actuator C.

The invention relates to a device of the type used to deliver fluids, in particular medicinal fluids, under pressure.

In many industrial sectors and notably in those of medicines and cosmetic products, it is necessary to deliver under pressure, fluids and principally liquids containing medicinal substances or cosmetics, or products consisting of natural products possibly modified or adapted, thus permitting utilisation of these fluids.

For example, isotonic sea water, which has applications, in particular for the washing of the nasal fossae, is one of these fluids.

There exist already devices of the type in question whose characteristics are disclosed in the U.S. Pat. Nos. 4,387,833, 4,423,829, 5,927,551 and 4,964,540.

In the case of these devices which can be operated in all positions, and even in the inverted position, the fluid is delivered, not by the action of a propellant gas, but under the action of a mechanical constraint, which is exerted on a container which is in the form of a pouch or flexible receptacle of variable volume and of generally cylindrical shape with longitudinal pleats, filled with the fluid to be delivered.

Still in the case of the devices disclosed in the above U.S. patents, the mechanical constraint, under the action of which the liquid contained within the container of variable volume is delivered under pressure, is exerted by a cylindrical sleeve of elastic, especially rubber material with particular elastic properties which envelops the container in the form of a pouch or flexible receptacle and whose diameter is slightly larger than the diameter of the container of variable volume when the latter is empty.

The sleeve in question is then put into place and the fluid to be delivered is introduced under pressure into the container which expands against the contrary action of the elastic sleeve of which the compression force exerted on the container increases with the expansion of said container due to the filling with the fluid to be delivered.

The container in the form of a pouch or flexible receptacle is equipped with an actuator which permits the activation of a valve to deliver the fluid, the whole being arranged inside a classic container or reservoir of the type used in the aerosol industry, notably in cosmetics or in personal care products.

These devices, which are very robust, have always given complete satisfaction to users but are penalised by their manufacturing cost due to the price of the rubber sleeve which forms part of their constitution.

Other devices of the type in question exist, wherein a container of variable volume, intended to be filled with the fluid to be delivered, and also equipped with an actuator adapted to activate a valve to permit the fluid under pressure to be delivered, is located inside an external container capable of resisting elevated pressures, notably in excess of 20 bars; this external container is filled with a neutral gas under pressure, the empty container of variable volume being in place and then the latter is filled with the fluid to be delivered, this fluid being introduced under a pressure which is sufficient to overcome the pressure exerted on the container by the neutral gas with which the external container is filled, which has as a consequence to further increase the pressure of the neutral gas.

In the case of these devices, the constraint exerted on the internal container of variable volume, and under the action of which the fluid under pressure may be delivered, is therefore of pneumatic nature.

These devices have not known a success comparable to those disclosed above, notably for reason of their fragility in case of impact or fall, notably at the level of the connection between the container of variable volume and the actuator whose operation permits the product under pressure to be delivered.

The invention has for object, above all, to remedy the inconveniences of the prior art and to provide the user with a device of the type in question which is free from the inconveniences presented by those which already exist.

And it is to the merit of the Applicant to have found that, surprisingly and unexpectedly, this objective is achieved in a device of the type in question as soon as a pneumatic constraint is exerted on a generally cylindrical shaped container of variable volume with longitudinal pleats containing, under pressure, the fluid to be delivered.

Consequently, the device according to the invention which is adapted to deliver fluids, notably medicaments, under pressure, is characterised by the fact that it comprises a container of variable volume in the form or shape of a pouch or flexible receptacle of generally cylindrical shape with longitudinal pleats containing the fluid under pressure to be delivered and equipped with an actuator permitting to open a valve to enable the aforementioned fluid to be delivered, the whole being located inside a container capable of resisting to an elevated internal pressure which is notably superior to 20 bars, the internal volume of the latter container comprised between its wall and the container of variable volume being filled with a neutral gas under a pressure sufficient to exert on the container of variable volume a pneumatic constraint sufficient to permit the delivery of the therein contained fluid when the aforementioned valve permitting said delivery is operated by the aforementioned actuator.

The external container of the device according to the invention being intended to contain a gas under pressure, should therefore be capable of resisting to a pressure higher than 5 bars, preferably higher than 8 bars, more preferably higher than 12 bars and possibly even be capable of supporting pressures in excess of 20 bars.

According to a particular embodiment, the container of variable volume containing the fluid to be delivered and the external pressure resisting container are made of transparent materials, allowing the user to see the fluid and to determine at every moment the state of filling of the device. Furthermore, any alteration of the fluid which could lead to a change in the aspect of said fluid (colouring, separation of phases, etc.) can be detected by the user.

The invention concerns also other features which are preferably used at the same time and which will be more explicitly discussed hereafter.

And the invention will be better understood with the help of the description which follows which relates to advantageous embodiments illustrated by the drawings in which:

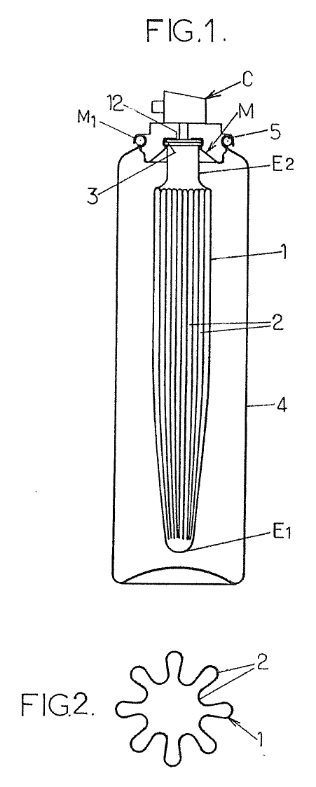

FIG. 1 is an external schematic view in elevation of a device according to the invention,

FIG. 2 is a sectional view on a larger scale in accordance with 2-2 of FIG. 1,

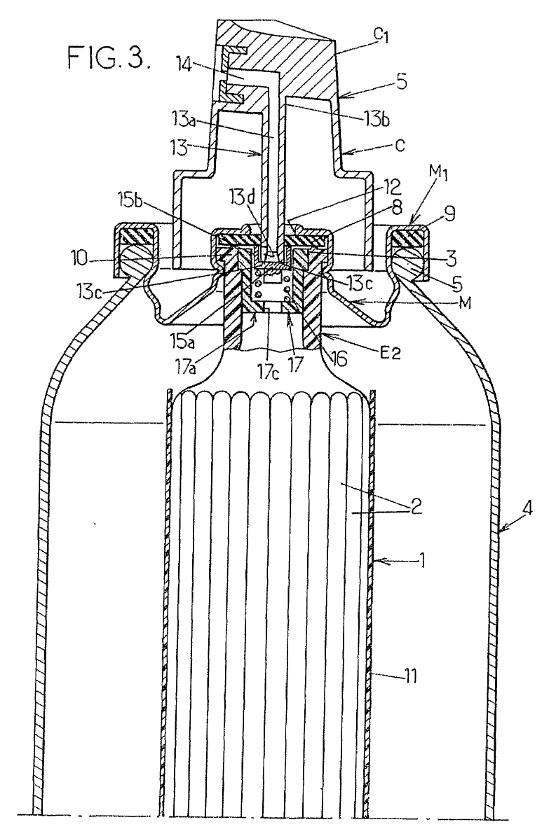

FIG. 3 is a partial view in section on a larger scale of the device according to FIG. 1.

As shown in FIGS. 1 and 2, the device according to the invention comprises
a container 1 designated as a whole by 1, in the form of a pouch or flexible receptacle of variable volume, of generally cylindrical shape with longitudinal pleats or ribs 2, closed at one of its extremities E₁ and presenting at its opposite extremity an opening having an edge 3 carried by a cylindrical extension E₂,
an external container 4, also cylindrical, comprising an opening with edges 5 and inside of which is located the container 1,
a mounting cup or sleeve designated as a whole by M connecting containers 1 and 4 which comprises a rim M₁ and a circular axial opening comprising an edge 12,
a command or actuator forming a push-button designated as a whole by C, arranged on the opening of the container 1,

the mounting cup M being crimped by its rim M₁ onto the edge 5 of the container 4, and by its central part which comprises the axial opening comprising the edge 12 on the extension E₂ close to the edge 3.

For the manufacture of the container 1, one may rely on the methods disclosed in the four U.S. patents identified above and, more particularly on U.S. Pat. No. 4,387,833 from column 3, line 63 to column 4, line 16.

It is during this manufacturing method that the mounting cup M, advantageously manufactured in aluminium or tinned steel or tinplate (steel bearing a coating of tin on each face), is crimped onto the edge 3.

Standard mounting cups existing in commerce, especially those having a mounting diameter of 25.4 mm, are advantageously used in such a way as to permit the use for the constitution of the external container 4 of containers intended for aerosols also available on the market, in particular those whose opening delimited by the edge 5 presents a diameter of 25.4 min, the aforesaid mounting cup being crimped onto the edge 5.

The containers 1 and 4 are advantageously made of aluminium, polyethyleneterephtalate, or tinned steel, or of any other synthetic material offering analogous properties.

In particular, the containers 1 and 4 may each be realized using laminated materials wherein at least one of the constitutive layers confers to the laminate sufficient mechanical resistance, while another layer may confer the properties of a barrier to gas, in particular to oxygen, nitrogen and/or carbon dioxide, and/or while another layer may still confer the properties of chemical resistance to the product to be delivered.

A layer adapted to confer good mechanical resistance may, for example, be constituted of polyethylene terephtalate or PET.

A layer adapted to confer good gas barrier properties may, for example, be realized in Nylon, especially Nylon MXD6, in ethylene vinyl alcohol resin (or EVOH), or in silicium oxide.

A layer adapted to confer good properties of chemical resistance may also, for example, be constituted in polyethylene terephtalate.

Accordingly, the container 1 may be constituted either by using a laminate of the type PET/Nylon/PET, that is to say comprising an external layer of polyethylene terephtalate, an intermediate layer of Nylon and an internal layer, that is to say a layer intended to be in contact with the fluid to be delivered, also of polyethylene terephtalate; or by using a laminate of the type PET/EVOH/PET.

Such a material of the type PET/Nylon/PET presents the additional advantage of being transparent, which is notably indicated when it is used in connection with the particular embodiment mentioned above in which the internal container of variable volume and the external container are made of transparent materials.

The container 4 may be advantageously realized in the same material. However, bearing in mind that the material constituting this container is not in contact with the fluid to be delivered, it is possible to use a bi-layer laminate, for example in polyethylene terephtalate and Nylon.

A material of this type which does not comprise an internal layer conferring chemical resistance may also be employed for the constitution of container 1, provided that the fluid to be delivered is chemically compatible with the other layers.

Such laminates may be realized by the employment of techniques of co-extrusion or co-injection with the help of technologies such as those developed by the company KORTEC Inc. Ipswich, Mass. 01938, USA.

It is also possible to contemplate the deposit of a layer, for example of silicium oxide, using the technique of vapour deposition. The layer so deposited may be extremely fine, that is only a few microns in thickness. The technology to be employed is, for example, the one developed by the company SIG Corpoplast Inc., under the name PLASMAX.

Such a layer may be deposited on a classic monolayer material or on a laminate obtained by co-extrusion or by co-injection.

According to the especially advantageous embodiment mentioned hereinabove, the internal and external containers, respectively 1 and 4, of the fluid delivery device according to the invention are made of a synthetic transparent material.

It has also been indicated hereinabove that in this particular embodiment, the user has the possibility to know at any moment the amount of fluid to be delivered which remains available inside the internal container 1.

While container 1 empties itself, the volume of said container decreases under the influence of the thereon exerted pneumatic effect, which permits the delivery of the therein contained fluid.

From experience, the “folding” of the internal container has a tendency to occur in a more or less “anarchistic” manner which may result in an uneven or more or less twisted shape of the internal container once “folded”.

It is essentially from an esthetical point of view that such an anarchistic folding should be avoided as, due to the transparency of the external container 4, the irregular deformations of the internal container 1 become visible to the user as the delivery of the therein contained fluid proceeds.

To overcome this drawback, the invention provides two solutions, each of which is implemented at a different step of the manufacture of the internal container 1.

This container of variable volume in the form of a pouch or of a flexible receptacle of generally cylindrical shape with longitudinal pleats is prepared in two steps, respectively step A and step B.

During the first step or step A, one prepares the container of variable volume in the form of a pouch or a flexible receptacle of generally cylindrical shape, the wall of said container being flat or even, while during the second step or step B, one provides said wall with the longitudinal pleats 2 which are shown, in particular, on FIGS. 1 and 2.

One relies on a preform K (prepared by injection inside a first mould) shown in axial section on FIG. 4 and made of the synthetic material of the container to be prepared; said preform K has the shape of a cylindrical tube closed at its extremity K1 and opened at its other extremity K2, said cylindrical tube being slightly conical (angle to apex or summit from 1° to 5°), the apex of the cone at the level of K1 comprising a protuberance K3; said protuberance K3 being designated by the word “gate” and corresponding to the introduction point, under pressure, of the fluid synthetic material into the mould.

Said preform K is transferred by indexation into a second mould in view of the previously mentioned first step or step A of the preparation of the internal container. Inside the second mould, said preform K is subjected to a mechanical elongation which is carried out using an element of the type stylet S, introduced through the opening of the preform and whose extremity S1 exerts an axial mechanical effect on the bottom of the preform at the level of its extremity K1. It is important that the protuberance K3 moves along the axis under the action of the stylet in the direction of the centre of the bottom of the blowing mould; said mechanical elongation is combined with a moulding by blowing inside the second mould according to the process designated in the art as “stretch blow”; said second mould has the form and the dimensions which permit the direct obtention of the pouch or flexible receptacle of generally cylindrical shape which constitutes container 1 which, at this stage, does not yet include the longitudinal pleats 2.

More particularly, in order to manufacture the pouch or flexible receptacle of generally cylindrical form, a pressure is exerted on the bottom of the preform with the help of the above-mentioned stylet, extending thus the preformed shape in the direction of the bottom of the mould. This operation ensures the centering of the bottom of the preform with the mould, the important result being that the preform is coaxially arranged with the mould. This operation is designated in the art as “to plant the gate”, which means that the preform remains coaxial with the second mould. Once the prolongation of the preform has been obtained under the action of the stylet, it is possible to introduce compressed air under high pressure (in the order of 12 to 25 bars) into the preform.

Under the effect of the pressure exerted by the compressed air, the preform extends or expands in all directions. The extension or expanding of its constituting material, which advantageously consists of polyethylene terephtalate or PET, is accompanied by an increase of its resistance to rupture; as a result of that extension or expanding, the wall of the container becomes thinner. This technique is designated by the expression “injection moulding” or “stretch-blow”.

The technical elements used in the first step or step A, i.e. the element which is used for the mechanical elongation as well as the second mould which enables to carry out the moulding-blowing or injection-moulding, are marketed notably by the company NISSEI ASB Company, 125 Westlake Parkway, Suite 120, ATLANTA, Ga. 30336 USA.

Now, during the second step or step B of the manufacture of the internal container 1, the generally cylindrical pouch or flexible receptacle, whose wall at that stage is still even, is provided with the longitudinal pleats 2, which are shown on FIGS. 1 and 2 using for example a device of the kind of those which are disclosed in U.S. Pat. No. 4,701,120 more particularly from line 50, column 1 to line 30, column 2.

That device comprises the elements which are designated in the art by the word “palettes” or blades and which permit the wall of the pouch or flexible receptacle of generally cylindrical shape to be provided with the longitudinal pleats.

In order to avoid any anarchistic “folding” of the internal container 1 as a consequence of the use of the fluid delivery device and in order to ensure that the said folding occurs in such a way that, when the totality of the fluid to be delivered has been blown out, the container resumes the shape it had before the introduction of the fluid to be delivered, one proceeds as follows according to the invention or along an equivalent way.

According to a first embodiment, the pleats or ribs 2 of container 1 are realized in two steps: the first step consisting in providing container 1 with preformed pleats 21.

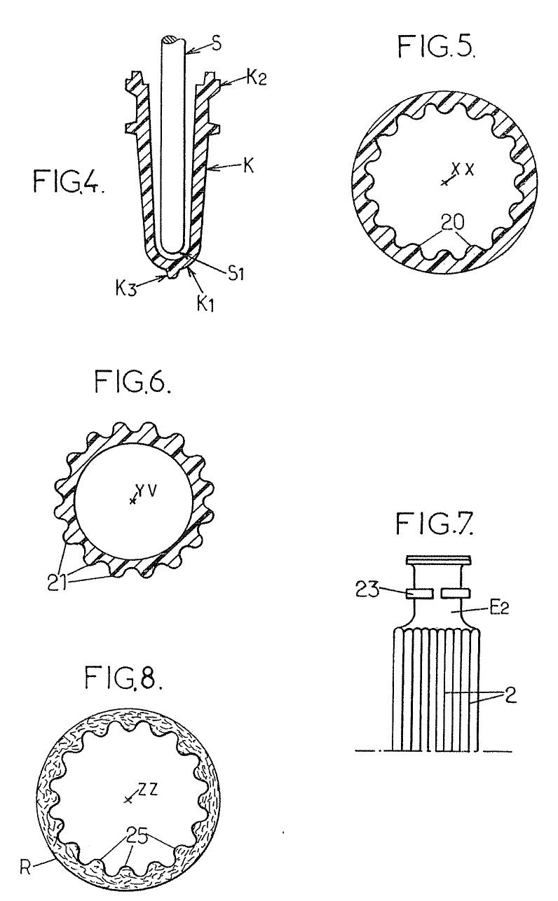

In this first embodiment, one uses a mould during the first step or step A, which is different from those used in the prior art by the fact that the internal surface of its constitutive wall, against which is applied during blowing the constituting material of the container 1 to be manufactured, is arranged in such a way which comprises longitudinal pleats 20, whose shape results from FIG. 5, FIG. 5 showing the mould used for moulding-blowing in sectional view perpendicular to its axis XX; these longitudinal pleats 20 provide the wall of the flexible receptacle or pouch of variable volume and of generally cylindrical shape constitutive of container 1 with longitudinal pleats 21, which are preforms of the future pleats 2 shown on FIG. 6, which is a sectional view perpendicular to the axis YY of the pouch or flexible receptacle of variable volume 1 once extracted from the mould and before it is introduced into the device used to elaborate the definite pleats 2, said device being used during the second step or step B.

In this second step, one can use the device mentioned above which is disclosed in U.S. Pat. No. 4,701,120.

The number of these preforms 21, which is generally equal to 16, must be the same as the number of “palettes” or blades comprised in the device used during the second step or step B to provide the container 1 with the definite longitudinal pleats 2.

Here a difficulty arises in connection with orientation and positioning.

It is necessary that the 16 preforms 21 comprised by the flexible receptacle or pouch of variable volume obtained at the end of the first step or step A, coincide with the parts of the device used during the second step or step B, wherein the “palettes” or blades provided during said step B provide the flexible receptacle or pouch with the definite pleats 2.

In order to permit the positioning of the flexible receptacle or pouch of variable volume obtained from the first step or step A, at the moment it is introduced in the device used during the second step or step B, in other words, to align the preform pleats 21 comprised by the flexible receptacle or pouch of variable volume obtained from the first step or step A, with parts of the device used during the second step or step B comprising the “palettes” or blades which realize the definite pleats 2, the extremity E2 of the flexible receptacle or pouch of variable volume may be provided with a notched support ring 23 shown on FIG. 7, said notched support ring permitting the obtention of the contemplated positioning described hereinafter.

The said notched support ring 23 permits transport of the flexible receptacle or pouch of variable volume inside the mechanism which dispatches it in the direction of the folding head at the level of which are realized the pleats 2 from the preform pleats 21, previously formed due to the conformation of the internal wall of the blowing mould. It is possible to consider a mechanism comprising a clic or abutment operated under the action of a spring in such a way that at the moment at which the clic or abutment is positioned at the level of the notch of the notched support ring, it penetrates in said notch to block the rotation of the flexible receptacle or pouch of variable volume, thus ensuring the contemplated positioning. In order to cause the rotation of the flexible receptacle or pouch of variable volume, it is possible to contemplate that the bearing part or support, which maintains the pouch or flexible receptacle of variable volume inside the “bottle holder”, is arranged in such a way that it permits said rotation under the action of a pneumatic rotative motor which, under the action of an actuator, rotates the said flexible receptacle or pouch inside the “bottle holder” until the position at which the clic or abutment plunges into the notch of the notched support ring to stop the flexible receptacle or pouch in the contemplated position.

Thus, it becomes possible for the preform pleats 21, with which the flexible receptacle or pouch of variable volume had been provided with during the moulding by blowing, to be aligned with the “palettes” or blades of the device used during step B.

It is due to the hereinabove described manufacturing procedure of the internal container 1, said procedures comprising the stage of realization of the preform pleats 21 before the realization of the definite pleats 2, that the folding of container 1 proceeds in such a way that it takes back its initial shape after the consumption of the totality of the fluid to be delivered.

According to a second embodiment which permits a uniform folding of the pouch or flexible receptacle of variable volume during the use of the fluid delivery device in such a manner that, once empty, the said pouch or flexible receptacle takes back its initial shape, which is the one it has at the end of the second step or step B, a cylindrical sleeve R is positioned on container 1 comprising the longitudinal pleats 2, said cylindrical sleeve R being shown on a sectional view perpendicular to its axis ZZ in FIG. 8; said sleeve R is made of an elastically synthetic material which is transparent and which comprises at its internal surface preformed longitudinal pleats 25 which are parallel to axis ZZ the number of which is the same as the number of longitudinal pleats 2 comprised by container 1 of variable form in such a way that each of the preformed pleats comprised by the cylindrical sleeve R positions itself between two pleats 2 of the flexible receptacle or pouch of variable volume 1.

The sleeve R is permanently maintained on container 1.

In order to ensure the positioning of sleeve R while it is put in place, with respect to the flexible receptacle or pouch of variable volume 1, it is again possible to use a notched support ring of the same type as ring 23 disclosed with respect to the first embodiment, said notched support ring being positioned at the opened extremity of the flexible receptacle or pouch of variable volume 1, as shown in FIG. 7.

With respect to the positioning, the procedure is the same as hereinabove disclosed with respect to the first embodiment.

Due to the presence of sleeve R, the folding of container 1 is done in a regular manner, container 1 retaking its initial shape once the totality of the fluid to be delivered has been used.

FIG. 3 shows in detail the constitutive parts of the device of the invention according to the present advantageous embodiment.

This figure shows the constitutive parts which have already been disclosed in connection with the schematic views of FIGS. 1 and 2.

As it is shown from FIG. 3, the tightness on the one hand concerning the level of the crimping of the mounting cup M on the extension E₂ close to edge 3 of the opening of the container 1, is secured by a gasket 8 consisting of elastomeric material, in particular rubber, and on the other hand, at the level of the crimping of the same mounting cup on edge 5 of the opening of container 4 by a gasket 9 consisting of the same material as the material of gasket 8.

It is also possible to contemplate elimination of the gasket 9 when the container 4 is realized in a material presenting sufficient elastic characteristics, for example in polyethylene terephtalate or in any other analogous synthetic material. The tightness of the package will then be made secure directly when realizing the crimping between edge 5 of the container and the mounting cup M by virtue of the elastic properties of the material. The absence of the gasket permits a reduction in cost.

The crimping of the mounting cup M on the extremity of the prolongation E₂ of the container 1 is rendered possible by an external edge 10 provided at its extremity.

It is possible to surround the container 1 by a cylindrical sleeve 11 which is advantageously manufactured from a synthetic material, in particular polyvinylethylene and whose function is to protect the container 1.

The mounting cup M is provided with a central circular opening whose edge is shown in 12.

The actuator C, which has the shape of a pressure button, has the general lines of a case in the shape of a hat, as shown in FIG. 3, and is advantageously made in a rigid synthetic material, notably in high density polyethylene; it includes an axial tube 13 with an internal axial passage 13a, which on the one hand communicates at its upper extremity 13b with a tube 14 located in the upper part C₁ of the actuator and connected to tube 13 and which, on the other hand, opens by its lower extremity 13c, when it is positioned as shown in FIG. 3 on the device of the invention, in the part E₂ of the container 1 through the opening 12 of the mounting cup M, the gasket 8 being arranged in such a way that it also ensures the tightness with tube 13 as shown.

The actuator C is therefore arranged and secured on the extremity E₂ of the container 1 due to the arrangement of the tube 13 in the opening comprising edge 3 of container 1 as shown.

The extremity 13c of the tube 13 rests on a valve constituted of an element in the form of a cup comprising a base 15a and a wall 15b; the tube 13 being provided at its extremity 13c with an opening or notch 13d.

In the closed position—under the action of a spring 16 arranged between the base 15a and the edge 17a of an element 17 in the form of a socket secured inside the end of the extremity E₂—the base 15a is pushed against the extremity 13c of tube 13 and the free edge of the wall 15b of the cup is pushed against the sealing gasket 8.

Element 17 comprises an axial passage 17c to ensure communication of the interior of container 1 with the interior of the space delimited by element 17.

To deliver the fluid under pressure contained within container 1, it is sufficient to exert on the actuator C in the direction of the container 1, a pressure higher than that with which the spring 16 applies the bottom 15a of the cup against the extremity 13c of tube 13 which has the effect of distancing the free edge of the wall 13b from the sealing gasket 8.

The fluid under pressure contained within container 1 may therefore pass between the free edge of the wall 15b and the sealing gasket 8 towards the inside of the cup and by the notch 13d provided at the extremity 13c of tube 13 into the axial passage 13a and then by the passage 14 towards the exterior under the form required.

To assemble the device according to the invention, one may proceed as follows:

The container 1, upon which has been secured the mounting cup M after the positioning of gasket 8, is preferably drained of most of the air which is contained therein.

The whole is then attached, after the positioning of gasket 9 by crimping on the external container 4 in which is therefore arranged the container 1, before introduction into the volume comprised between the wall of container 4 and the external surface of container 1, of air or neutral gas under pressure in a quantity sufficient for bringing the pressure to a value preferably comprised between about 1.5 bars and about 3.5 bars, the precise value of the said pressure being chosen in accordance with the nature of the fluid to be delivered.

In view of introducing the neutral gas, one may proceed as follows using a suitable tool, for example an under the cup gasser crimper of the type marketed by the company Pamasol Willi Maeder AG, Driesbuelstrasse 2, CH-8808 Pfaffikon, SZ Switzerland under the name “Tête UTC” (i.e. “UTC Head”). This tool ensures the tightness at the level of the upper surface of the container 4 and lifts slightly the mounting cup M, using a connection by vacuum to pull by aspiration the mounting cup into a seat, and to permit the introduction under pressure of a neutral gas or of compressed air. Once the gas has been introduced, the mounting cup M is pressed against the edge 5 of the container 4 and the head and then, a crimping is made between the cup M and container 4. During this operation a pressure is maintained by the head to compress gasket 9 and therefore ensure a good tightness between the mounting cup M and the container 4.

The container 1 is then filled with the fluid intended to be delivered under pressure.

In that respect, it is possible to have recourse to a so-called metering unit, for instance that which is marketed by the company Pamasol Willi Maeder AG, Driesbuelstrasse 2, CH-8808 Pfaffikon, SZ Switzerland under the name “Remplisseuse volumétrique sous pression” (i.e. “Volumetric pressure-filling machine”). This quantity determining unit generally comprises a device for volumetric quantity determination under high pressure and a filling nozzle. Once the mounting cap M is crimped on container 4, the whole is positioned under a filling nozzle which is part of the metering unit and the nozzle is operated to come down and to ensure tightness on the mounting cup. Tightness on the higher part 12 of the mounting cup is ensured by using an adapter and the fluid is introduced under pressure through valve 15 in order to fill container 1.

Due to the increase in volume of container 1 as a consequence of the introduction of the fluid, the pressure of the air or of the neutral gas comprised between the wall of container 4 and container 1 increases and reaches generally a value comprised between about 4 bars and about 10 bars, the precise selected value being a function of the nature of the liquid to be delivered.

Actuator C is then positioned and the device according to the invention is ready for use.

Consequently and whatever the selected embodiment of the device according to the invention, the features of the latter sufficiently result from the foregoing description, the said device presenting, with respect to those which already exist, a number of advantages among which, in particular, those of an elevated reliability, of a high robustness and of an interesting cost price.

1. A device adapted to deliver fluids, notably medicaments, under pressure, characterised by the fact that it comprises a container of variable volume in the form or shape of a pouch or flexible receptacle of generally cylindrical shape with longitudinal pleats containing the fluid under pressure to be delivered and equipped with an actuator C permitting to open a valve to enable the delivery of said fluid, the whole being located inside a container capable of resisting to an elevated internal pressure which is notably superior to 20 bars, the internal volume of the latter container comprised between its wall and the container of variable volume being filled with a neutral gas under a pressure sufficient to exert on the container of variable volume a pneumatic constraint sufficient to permit the delivery of the therein contained fluid when the above-said valve permitting said delivery is operated by the aforementioned actuator.

2. A device according to claim 1, characterized by the fact that it comprises:
a container in the form of a pouch or flexible receptacle of variable volume, of generally cylindrical shape with longitudinal pleats or ribs, closed at one of its extremities and presenting at its opposite extremity an opening having an edge carried by a cylindrical extension,
an also cylindrical external container 4 comprising an opening with edges and inside of which is located the container,
a mounting cup or sleeve connecting the containers which comprises a rim and a circular axial opening comprising an edge,
a command or actuator forming a push-button arranged on the opening of the container,
the mounting cup being crimped by its rim onto the edge of the container, and by its central part which comprises the axial opening comprising the edge on the extension close to the edge.

3. A device according to claim 1, characterized by the fact that the container is made of polyethyleneterephtalate (PET) or any other synthetic material offering analogous properties and that the mounting cup which is crimped onto edge is made of aluminium or tinned steel or tinplate (steel bearing a coating of tin on each face), the container being made of aluminum, polyethyleneterephtalate or of tinned steel.

4. A device according to anyone of claim 1, wherein the tightness on the one hand, concerning the level of the crimping of the mounting cup M on the extension E₂ close to edge of the opening of the container, is secured by a gasket consisting of elastomeric material, in particular rubber, and on the other hand, at the level of the crimping of the same mounting cup on edge of the opening of container by a gasket consisting of the same material as the material of gasket, the crimping of the mounting cup on the extremity of the prolongation of the container is rendered possible by an external edge provided at its extremity.

5. A device according to claim 1, characterized in that the actuator, which has the shape of a pressure button having the general lines of a case in the shape of a hat, which is advantageously made in a rigid synthetic material, notably in high density polyethylene and includes an axial tube with an internal axial passage, which on the one hand communicates at its upper extremity with a tube located in the upper part of the actuator and connected to tube and which, on the other hand, opens by its lower extremity, when it is positioned on the device, in the part of the container through the opening of the mounting cup, the gasket being arranged in such a way that it also ensures the tightness with the tube, the said actuator being arranged and secured on the extremity of the container due to the arrangement of the tube in the opening comprising edge of container the extremity of the tube resting on a valve constituted of an element in the form of a cup comprising a base and a wall, the tube being provided at its extremity with an opening or notch.

6. A device according to claim 5, characterized by the fact that in the closed position—under the action of a spring arranged between the base and the edge of an element in the form of a socket secured inside the end of the extremity—the base is pushed against the extremity of tube and the free edge of the wall of the cup is pushed against the sealing the gasket, and element comprising an axial passage to ensure communication of the interior of container with the interior of the space delimited by element.

7. A device according to claim 1, characterized in that the containers are made of transparent materials.

8. A device according to claim 1, characterized in that the containers are realized using laminated materials, wherein at least one of the constitutive layers confers to the laminate sufficient mechanical resistance, while another layer confers the properties of a barrier to gas, in particular to oxygen, nitrogen and/or carbon dioxide, and still another layer confers the properties of chemical resistance to the product to be delivered.

9. A device according to claim 8, characterized in that:
the layer adapted to confer good mechanical resistance is constituted of polyethylene terephtalate or PET,
the layer adapted to confer good gas barrier properties is realized in Nylon, Nylon MXD6, ethylene vinyl alcohol resin (or EVOH), or in silicon oxide,
the layer adapted to confer good properties of chemical resistance is constituted of polyethylene terephtalate.

10. A device according to claim 8, characterized in that the container is realized either by using a laminate of the PET/Nylon/PET type, that is to say that it comprises an external layer of polyethylene terephtalate, an intermediate layer of Nylon and an internal layer, that is to say a layer intended to be in contact with the fluid to be delivered, of polyethylene terephtalate or by using a laminate of a PET/EVOH/PET type, the container being advantageously realized in the same material or in a bilayer laminate, notably in polyethylene terephtalate and Nylon.

11. A device according to claim 1, characterized in that the pleats or ribs of container are realized in two steps during the first of which consisting in providing container with preformed pleats.

12. A device according to claim 1, characterized in that it comprises a cylindrical sleeve positioned on container said sleeve is made of an elastical synthetic material which is transparent and which comprises at its internal surface preformed pleats, each of them being positioned between two pleats of the container.
